(19) United States
(12) Patent Application Publication
(10) Pub. No.: US 2018/0080268 A1
(43) Pub. Date: Mar. 22, 2018

(54) PIVOT SLIDING DOOR ASSEMBLY FOR A VEHICLE

(71) Applicant: Gebr. Bode GmbH & Co. KG, Kassel (DE)

(72) Inventor: Nils Gibhardt, Gudensberg (DE)

(21) Appl. No.: 15/708,613

(22) Filed: Sep. 19, 2017

(30) Foreign Application Priority Data
Sep. 19, 2016 (DE) 202016105214.9

(51) Int. Cl. E05D 15/10

(52) U.S. Cl. CPC E05D 15/1007; E05D 2015/1039; B60J 5/062; E05Y 2900/51; E05Y 2900/506; E05D 2015/1026

(57) ABSTRACT

A pivot sliding door assembly for a vehicle with a door wing for opening and closing a door opening. The pivot sliding door assembly is secured against disengagement in a Z-direction. The assembly includes a rotary column assembly for displacing the door wing between a closing position and a displacing or open position. The door wing closes the door opening when in the closing position and the door wing can be displaced in the displacing position for opening the door opening along a displacement direction.

### CROSS-REFERENCE TO RELATED APPLICATION(S)

This application claims priority under 35 U.S.C. § § 119(a)-(d) to German application no. 20 2016 105 214.9 filed Sep. 9, 2016 entitled “Pivot Sliding Door Assembly for a Vehicle,” which is hereby expressly incorporated by reference as part of the present disclosure.

### FIELD OF THE INVENTION

The invention relates to a pivot sliding door assembly for a vehicle.

### BACKGROUND

Generally, in pivot sliding doors, the door wings should be fixed in the closed position in relation to movement in a vertical direction, which vertical direction is also referred to as the Z-direction. While the vehicle is in motion, vibrations usually arise, which may also cause the door wings to pivot in the Z-direction.

One known approach for fixing motion of the door wing in the Z-direction is to provide a horizontal groove on a lower rotary column bearing of the pivot sliding door, the horizontal groove extending along a displacement direction of the door wing of the pivot sliding door. While closing the door, a lead-in wedge enters into that groove, thus blocking vibrations of the door wing in the Z-direction. This displacement direction corresponds to a travelling direction or a longitudinal direction of the vehicle, respectively, hereinafter referred to as the Y-direction.

However, the disadvantage with this approach resides in that vibrations of the door wing, both in the Y-direction of the door wing and in an X-direction, which X-direction is perpendicular to that Y-direction and to the Z-direction, may result in the above-described engagement between the lead-in wedge and the groove for fixing the door wing in the Z-direction becoming disengaged. This situation may result in damages to the sliding door or the drive thereof, especially during drive operation of the vehicle.

### SUMMARY

It is an object of embodiments of the invention to address one or more of the above-described deficiencies of known pivot sliding doors.

It is also an object of the invention is to provide a pivot sliding door assembly, which is secured against disengagement of its Z-direction fixation in a reliable and cost-effective manner.

With respect to a pivot sliding door assembly for a vehicle with a door wing for opening and closing a door opening, these objects are met by various embodiments of the present invention.

The pivot sliding door assembly according to some embodiments of the invention comprises a door wing for opening and closing a door opening, and a rotary column assembly for moving the door wing between a closing position and an opening (i.e., displacing) position. A rotary column lever couples the rotary column to the door wing for opening the door wing. The pivot sliding door assembly includes a device that securely fixes the door wing in the Y-direction. Thus, movement of the door wing in the Y-direction will be suppressed, thereby preventing disengagement of the mechanism suppressing movement of the door wing in the Z-direction.

Some embodiments include a pivot sliding door assembly for a vehicle. The pivot sliding door assembly includes a door wing configured to open and close a door opening. The pivot sliding door assembly also includes a rotary column assembly configured to displace the door wing in a displacement direction between a closing position and a displacing position. The rotary column assembly includes a rotary column pivotable to displace the door wing and a rotary column lever coupling the rotary column to the door wing. The rotary column lever includes a Y-direction fixing device engageable with the door wing in the closing position. Engagement of the Y-direction fixing device thereby fixes the door wing in the displacement direction. The rotary column lever also includes a guiding element. The door wing includes a linear bearing into which the guiding element engages, so as to linearly guide the door wing in the displacement direction. When the door wing is in the closing position, the door opening is closed. The door wing can be displaced when in the displacing position to open the door opening along the displacement direction

In some embodiments, the displacement direction extends in a horizontal direction in relation to the vehicle. In some embodiments, the displacement direction extends co-linearly with a travelling direction of the vehicle. In some embodiments, the Y-direction fixing device, in the displacing position of the door wing, is alternatingly engageable and disengageable with the door wing. In some embodiments, the Y-direction fixing device is disengageable from the door wing, by pivoting the rotary column with the door wing.

In some embodiments, the rotary column assembly comprises a Z-direction fixing device engageable with the door wing in the closing position of the door wing. Engagement of the Z-direction fixing device thereby limits movement of the door wing in a Z-direction, transversely to the displacement direction. In some embodiments, the Z-direction, in relation to the vehicle, extends in a vertical direction. In some embodiments, the Z-direction fixing device is engageable with the door wing, so as to limit motion of the door wing in an upward Z-direction and a downward Z-direction. In some embodiments, the Y-direction fixing device includes the Z-direction fixing device. In some embodiments, engagement of the Y-direction fixing device with the door wing fixes the door wing in the Z-direction.

In some embodiments, the rotary column assembly includes an X-direction pressing device engageable with the door wing in the closing position of the door wing. The X-direction pressing device is configured to press the door wing in an X-direction. In some embodiments, the X-direction extends perpendicularly to the displacement direction and perpendicularly to the Z-direction. In some embodiments, the X-direction extends horizontally in relation to the vehicle.

In some embodiments, the pivot sliding door assembly includes a second door wing configured to open and close the door opening. The second door wing is displaceable between a second closing position and a second displacing position. The door wing, when in the closing position, together with the second door wing, when in the second closing position, covers the door opening. The X-direction pressing device presses the door wing, when in the closing position, against the second door wing, when in the second closing position. In some embodiments, the pivot sliding door assembly defines a portal delimiting the door opening, and the X-direction pressing device presses the door wing in the closing position against the portal.

In some embodiments, the door wing defines an opening configured to receive the Y-direction fixing device. The Y-direction fixing device is displaceable into the opening to engage the door wing. In some embodiments, the opening is located near an end region of and adjacent to the linear bearing.

In some embodiments, the Y-direction fixing device includes a hook configured to engage the door wing. In some embodiments, upon engagement of the Y-direction fixing device, the hook engages behind an engaging edge of the opening. In some embodiments, when the hook engages the engaging edge of the opening, the door wing is pressed in the X-direction. In some embodiments, the opening defines an elongated hole oriented along the displacement direction. In some embodiments, the opening is located below the linear bearing. In some embodiments, the opening defines sub-edges delimiting the engaging edge, and configured to block a relative movement of the hook towards the opening transversely to the displacement direction. In some embodiments, the sub-edges are configured to block a relative movement of the hook both upwardly and downwardly in the Z-direction, by a form-fit with the hook. In some embodiments, a clearance of the hook in the opening in the Z-direction is smaller than a clearance of the guiding element in the linear bearing in the Z-direction. In some embodiments, the hook is located at a pin of the rotary column lever. In some embodiments, the hook is located near a door wing side end of the rotary column lever. In some embodiments, the pin is oriented vertically downwards. In some embodiments, the hook is oriented substantially along a horizontal plane of the vehicle. In some embodiments, wherein the hook is bent in a direction that corresponds to a pivot direction of the rotary column for displacing the door wing into the closing position.

In some embodiments, the rotary column lever is pivotably supported at the rotary column. In some embodiments, the rotary column lever is displaceably supported with the guiding element in the linear bearing. In some embodiments, the guiding element includes a rolling element configured to linearly roll door wing along a guide. In some embodiments, the linear bearing defines a longitudinal profile. In some embodiments, the longitudinal profile defines a profile cross section that is open only in a first transverse direction. In some embodiments, the rolling element is rotatably supported at an axis of rotary column lever that, along the transverse direction, protrudes into the longitudinal profile and is located at a door wing side end of the rotary column lever.

Further advantages and features of the invention arise and will be apparent from the following description reference to the accompanying figures.

### BRIEF DESCRIPTION OF THE DRAWINGS

FIG. 1 is a view of a pivot sliding door assembly as seen from an inner direction of the vehicle;

FIG. 2 is a perspective view of the pivot sliding door assembly of FIG. 1, as seen from an obliquely lower inner direction of the vehicle;

FIG. 3 is an upper sectional view of the pivot sliding door assembly of FIG. 1; and

FIG. 4 is a sectional view of the pivot sliding door assembly of FIG. 1 as seen transversely to a longitudinal direction of the vehicle.

### DETAILED DESCRIPTION OF EMBODIMENTS

Embodiments of pivot sliding door assemblys are described herein with reference to the Figures herein.

In at least some embodiments, on the rotary column lever that couples the rotary column to the door wing for turning out the door wing upon unlocking the pivot sliding door, a device is provided, which, in a closing position of the door wing in the Y-direction, securely fixes the door wing. Thus, in this way movement of the door wing in the Y-direction will be suppressed so that disengagement of the Z-direction fixation by displacement into the Y-direction will be prevented.

The pivot sliding door assembly according to certain embodiments is designed for vehicles, such as buses, trains, or other vehicles for public transportation. The pivot sliding door according to some embodiments of the invention assembly comprises a door wing for opening and closing a door opening, and a rotary column assembly for displacing the door wing between a closing position and a displacing position. In some embodiments, the rotary column assembly comprises a pivotable rotary column for displacing the door wing and a rotary column lever for attaching the rotary column to the door wing, the door wing having a linear bearing. In certain embodiments, a guiding element of the rotary column lever engages into the linear bearing for linear guide of the door wing in a displacement direction. In some embodiments, the door wing, in the closing position, locks the door opening and, in the displacing position, may be displaced along the displacement direction for opening the door opening. In other embodiments, in certain positions of displacement of the door wing along or in the displacement direction, displacement of the door wing into the closing position is not possible. In other words, it is possible that the door wing may be displaced to the closing position by the rotary column assembly only in one or more specified positions of the displacement of the door wing along the displacement direction. In certain embodiments, the linear bearing of the door wing and the guiding element of the rotary column lever form a linear guide.

In some embodiments, the rotary column lever comprises a Y-direction fixing device, which, for fixing the door wing in the displacement direction, engages the door wing in the closing position of the door wing. In other words, engagement of the Y-direction fixing device of the rotary column lever into the door wing prevents a relative movement of the door wing in relation to the rotary column assembly in the displacement direction. In certain embodiments, the Y-direction fixing device and the door wing form a form-fit in the displacement direction by the engagement. This prevention of movement may relate to movement along a first orientation of the displacement direction or along a second orientation of the displacement direction opposite of the first orientation. Thus, if the displacement direction is defined by a vector, the prevention may relate either to a movement parallel to this vector or to a movement antiparallel to this vector.

In some embodiments, the displacement direction is horizontal in relation to the vehicle. In this context, in some embodiments the displacement direction is co-linear to a travel direction of the vehicle. Accordingly, this encompasses both an orientation parallel to the travelling direction and an orientation antiparallel to the travelling direction of the displacement direction. The displacement direction may—as already mentioned above—also be referred to as the Y-direction.

In other embodiments, the Y-direction fixing device, in the displacing position of the door wing, is disengaged with the door wing. The Y-direction fixing device may alternatingly be engaged and disengaged with the door wing by pivoting the rotary column. In further embodiments, pivoting the rotary column actuates the rotary column lever so that the Y-direction fixing device is alternatingly engaged and disengaged with the door wing. In yet further embodiments, the Y-direction fixing device may be engaged with the door wing by pivoting the rotary column only in positions to where the door wing may be displaced along the displacement direction by the rotary column assembly from the closing position.

In some embodiments, the rotary column assembly has a Z-fixing device, which, in order to limit movement of the door wing in a Z-direction transversely to the displacement direction, comes into engagement with the door wing in the closing position of the door wing. In certain embodiments, the Z-direction, in relation to the vehicle, extends in a vertical direction. In some embodiments, any orientation or both orientations of this vertical pathway apply to the orientation of the engagement. In some embodiments, the Z-fixing device comes into engagement with the door wing for limiting a movement of the door wing in an upward Z-direction and a downward Z-direction. In some embodiments, the engagement may limit motion in both directions depending on the vibrations that the door wing experiences. In certain embodiments, this limitation of movement of the door wing corresponds to a fixing of the door wing.

The above-mentioned Z-direction fixing device may be configured separately and independently from the Y-direction fixing device. However, in some embodiments, the Y-direction fixing device encompasses or includes the Z-direction fixing device. The Y-direction fixing device may also be identical to the Z-direction fixing device. In certain embodiments, engagement of the Y-direction fixing device with the door wing fixes the door wing in the Z-direction.

In some embodiments, the rotary column assembly has an X-direction pressing device, which, in the closing position of the door wing, is engaged in the door wing for pressing the door wing along an X-direction. This X-direction may be any direction. However, in certain embodiments, the X-direction is perpendicular to the displacement direction and perpendicular to the Z-direction. In some embodiments, the X-direction extends horizontally in relation to the vehicle. The X-direction may be a horizontal direction which is transverse to the Y-direction. In this context, the Y-direction fixing device may also encompass the X-direction pressing device or may consist of it.

In some embodiments, the door wing has an opening for accommodating the Y-direction fixing device and the Y-direction fixing device is displaced into the opening for engaging the door wing. In other words, the Y-direction fixing device moves into the opening to engage with the door wing. In doing so, in certain embodiments, displacement of the Y-direction fixing device may be accomplished by operating the rotary column lever, which may be achieved by pivoting the rotary column. In some embodiments, the opening is arranged in an end range of the linear bearing and adjacent to the linear bearing.

In some embodiments, the linear bearing is arranged at a lower end of the door wing. Accordingly, the rotary column lever then is a lower rotary column lever.

In some embodiments, the pivot sliding door assembly has another door wing for opening and closing the door opening, so that the other door wing may be displaced between a closing position and a displacing or open position. In further embodiments, the other door wing in the closing position, together with the door wing in the closing position, covers the door opening and the X-direction pressing device presses the door wing in the closing position against the other door wing in the closing position. In some embodiments, the pivot sliding door assembly has a portal for limiting the door opening and the X-direction pressing device presses the door wing in the closing position against the portal. In certain embodiments, the portal is any structure which completely or partly forms the boundary of the door opening.

In some embodiments, the Y-direction fixing device comprises a hook for engagement with the door wing. In certain embodiments, the hook engages behind an engaging edge of the door wing opening. Engagement may thus specifically be between the hook and the engaging edge of the opening. The engaging edge may form an edge of the opening in the displacement direction, and fixing in the displacement direction may be effected by engagement of the Y-direction fixing device with the engaging edge. Between the hook and the engaging edge, a form-fit in the displacement direction may be created through the engagement. In some embodiments, the hook engages behind the engaging edge of the opening for pressing the door wing along against the X-direction. The X-direction pressing device may consequently comprise the hook.

In some embodiments, the opening is a long hole, which is oriented along the displacement direction. The opening may be arranged below the linear bearing.

In some embodiments, sub-edges of the opening limit the engaging edge to block a relative movement of the hook in relation to the opening transversely to the displacement direction, for example, along both the upper and lower orientations upward and downward directions of the Z-direction, by form-fit with the hook. These sub-edges may be edges of the opening, which limit the engaging edge and extend especially angularly—i.e. non-co-linearly—to the engaging edge. The sub-edges may substantially extend perpendicular to the engaging edge. In certain embodiments, a clearance of the hook in the opening in the Z-direction is smaller than a clearance of the guiding element in the linear bearing in the Z-direction. In this way, despite a clearance of the hook being present in Z-direction, the guiding element may be prevented from exiting the linear bearing.

In some embodiments, the hook is arranged on a pin of the rotary column lever. The hook may have an extension perpendicular to a longitudinal direction of the pin. In further embodiments, the hook is arranged closer to a door wing side end of the rotary column lever and the pin is oriented vertically downwards.

In some embodiments, the hook is oriented substantially along a horizontal plane of the vehicle. Where the hook is configured in a bent manner, the curve defining the bend may substantially be in the horizontal plane of the vehicle. In certain embodiments, the hook is bent in a direction that corresponds to a pivot direction of the rotary column for displacing the door wing in the closing position. Thus, if the rotary column is pivoted in the clockwise direction for displacing the door wing into the closing position, the hook may be also bent in the clockwise direction and vice versa. Reference to the pivot direction or the bending direction, respectively, is based on the joint plane for both pivoting the rotary column and bending the hook.

In some embodiments, the rotary column lever is pivotably supported on the rotary column. The rotary column lever may be displaceably supported with the guiding element in the linear bearing.

This displacement may be a linear movement in the displacement direction. In some embodiments, the linear bearing is a slide bearing, and the guiding element has a slide element for guiding linear sliding motion of the door wing. In certain embodiments, the guiding element has a rolling element for guiding linear rolling of the door wing.

In some embodiments, the linear bearing has a longitudinal profile. In further embodiments, the profile is an elongated profile element. The linear bearing may also consist of such a longitudinal profile. In certain embodiments, a profile cross section of the longitudinal profile is only open toward one transverse direction. In some embodiments, the profile cross section is closed towards three directions that are perpendicularly oriented to this transverse direction. This may assure safe accommodation of the guiding element in the linear bearing. In certain embodiments, the rolling element is rotatably supported at an axis of the rotary column lever, which axis protrudes into the longitudinal profile along the transversal direction and which axis is arranged at an door wing side end of the rotary column lever.

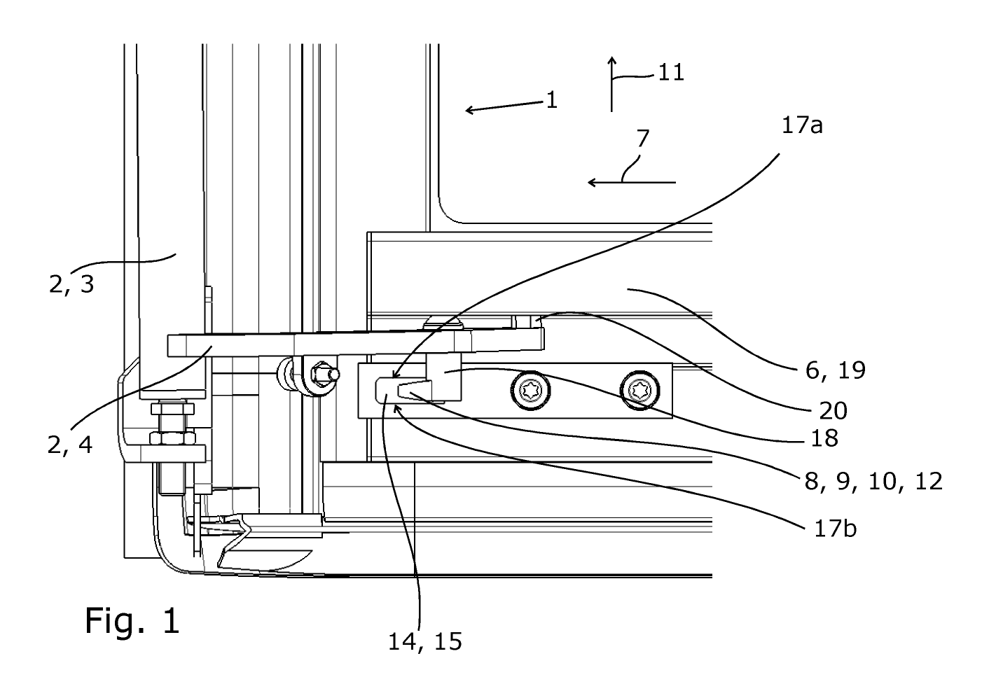

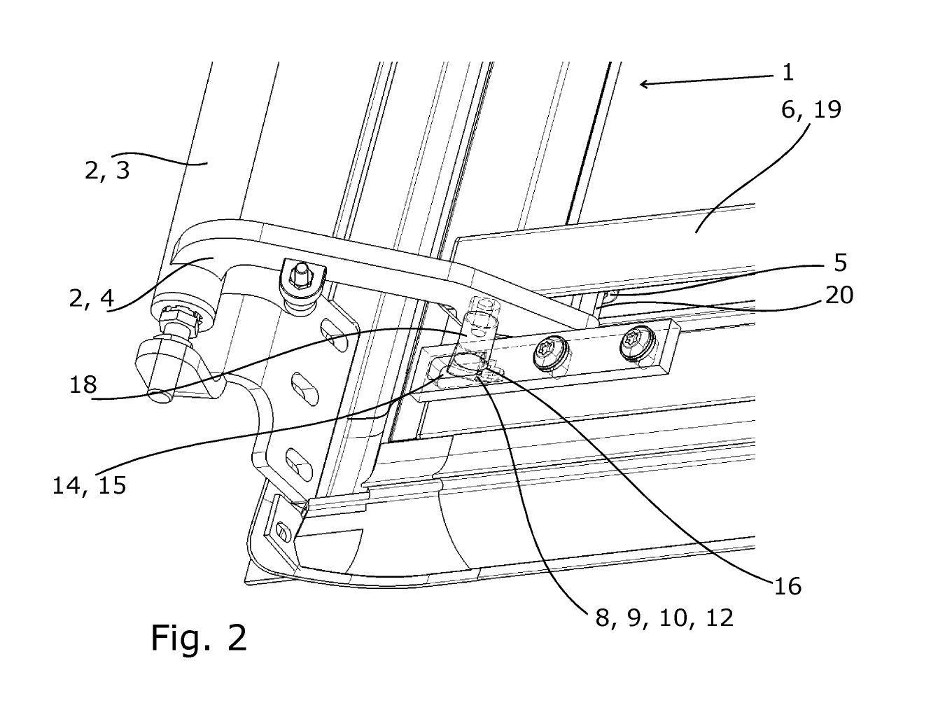

The pivot sliding door assembly of FIGS. 1 to 4 may be used for a vehicle. It comprises a door wing 1, which in the representation of FIGS. 1 to 4 is in a closing position, closing a door opening (not shown). The pivot sliding door assembly furthermore comprises a rotary column assembly 2, by means of which the door wing may be displaced between this closing position and a displacing or open position (not shown). For this purpose, the rotary column assembly 2 comprises a rotary column 3, of which only the lower portion is shown in the Figures, and a rotary column lever 4. The rotary column lever 4, with its rotary column side end, is pivotably supported at the rotary column 3 and comprises a guiding element 5 at its door wing side end. This guiding element 5 is a guiding pulley with a vertical rotary axis, which engages in a linear bearing 6 of the door wing 1. This engagement is for linearly guiding the door wing 1 towards a horizontal displacement direction 7, which displacement direction 7 may also be referred to as Y-direction, and which corresponds to the travelling direction of the vehicle. The rotary column lever 4 comprises a Y-direction fixing device 8, which fixes the door wing 1 in the displacement direction 7, and for this purpose form-fittingly engages the door wing 1.

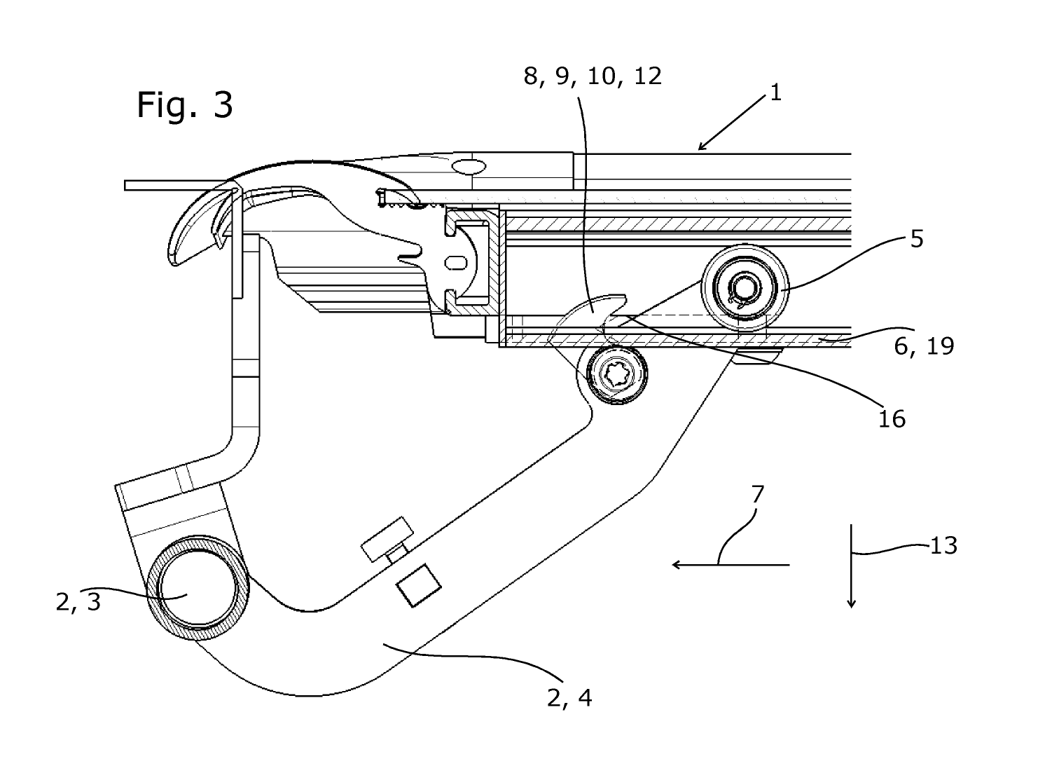

As seen in FIGS. 1 and 3, displacement of the door wing 1 in the displacement direction 7 is blocked by this engagement. In the illustrated embodiment, the Y-direction fixing device 8 includes a hook 9. As seen in FIG. 3, pivoting the rotary column 3 in a counterclockwise direction by way of the resulting operation of the rotary column lever 4 disengages the hook 9 from the door wing 1, thereby displacing the door wing 1 into the displacing position. At that point, the bend of the hook extends, opposite to this direction, in the clockwise direction, as seen in FIG. 3.

The hook 9 defines a Z-direction fixing device 10. In the vertical Z-direction 11, i.e. both in the upward and downward Z-direction 11, the hook 9 engages with the door wing 1, so as to limit movement of the door wing 1 along the Z-direction 11 by way of a form-fit of the hook 9 with the door wing 1. As shown in FIGS. 1 to 4, there is a clearance along the Z-direction 11 between the hook 9 and the door wing 1, so that the above engagement will occasionally not occur until the door wing 1 passes through a certain displacement distance.

The hook 9 also forms an X-direction pressing device 12, since engagement of the hook 9 with the door wing 1 noticeably presses the door wing 1 along or in an X-direction 13, which X-direction 13 transversely extends both towards the displacement direction 7 and the Y-direction 11. In this way, the door wing is pressed both against another door wing (not shown) and against a portal (not shown) for limiting the door opening.

Referring now to the engagement of the hook 9 with the door wing 1, the door wing 1 has an opening 14 for accommodating or receiving the Y-direction fixing device 10, which is an elongated hole 15 arranged below the linear bearing 6 at an end region of the linear bearing 6 and oriented along the displacement direction 11. The above-described pivoting of the rotary column 3 operates the rotary column lever 4 such that the hook 9 will be displaced into the elongated hole 15. The hook 9 specifically engages behind an engaging edge 16 of the elongated hole 15. The form-fit of the hook 9 for fixing in the Z-direction 11 is done by sub-edges 17a, b of the elongated hole 15, which each vertically limit the engaging edge 15 on top and at the bottom.

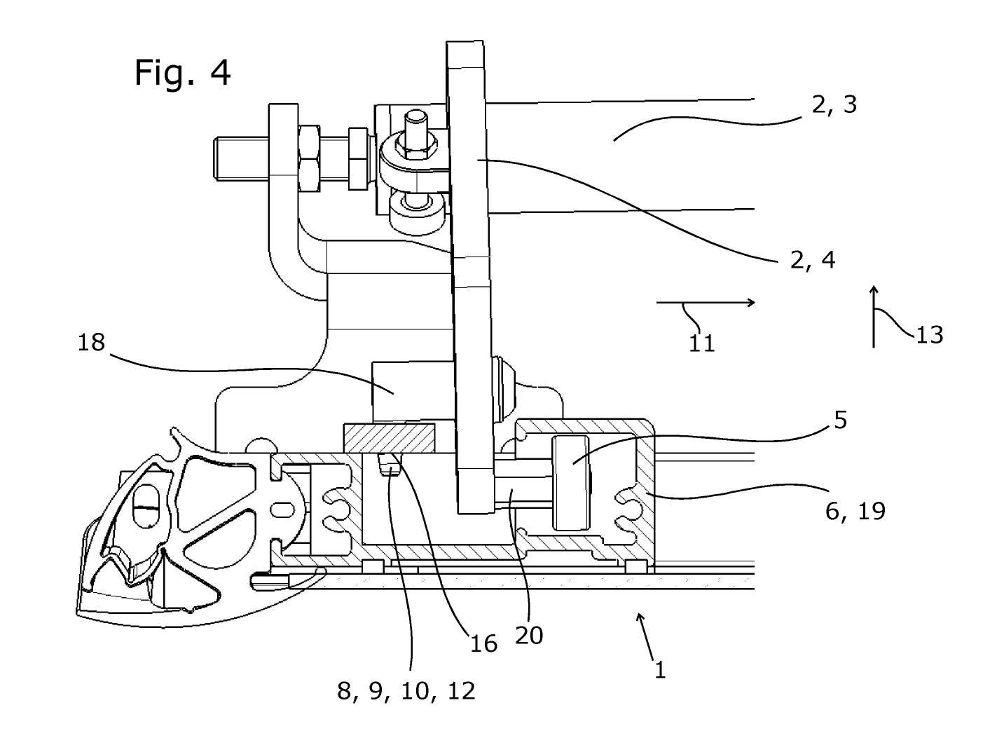

The hook 9 is arranged or located at or on a vertical-upwardly oriented pin 18 of the rotary column lever 4. The linear bearing 6 has a longitudinal profile 19, which—as it is seen especially from FIG. 4, is only open in the vertically downward Z-direction 11. The guiding element 5 is rotatably supported at an axis 20 of the rotary column lever 4, which extends along this Z-direction 11 into the longitudinal profile 19.

As may be recognized by those or ordinary skill in the pertinent art based on the teachings herein, numerous changes and modifications may be made to the above-described and other embodiments of the present invention without departing from its scope as defined, for example, in the appended claims. Accordingly, this detailed description is to be taken in an illustrative as opposed to a limiting sense.

What is claimed is:

1. A pivot sliding door assembly for a vehicle, comprising:
a door wing configured to open and close a door opening; and
a rotary column assembly configured to displace the door wing in a displacement direction between a closing position and a displacing position, wherein the rotary column assembly comprises
(i) a rotary column pivotable to displace the door wing, and
(ii) a rotary column lever coupling the rotary column to the door wing, the rotary column lever including a Y-direction fixing device engageable with the door wing in the closing position, thereby fixing the door wing in the displacement direction, and a guiding element;
wherein the door wing includes a linear bearing into which the guiding element engages so as to linearly guide the door wing in the displacement direction;
wherein, when the door wing is in the closing position, the door opening is closed; and
wherein the door wing can be displaced when in the displacing position to open the door opening along the displacement direction.

2. The pivot sliding door assembly according to claim 1, wherein the displacement direction extends in a horizontal direction in relation to the vehicle.

3. The pivot sliding door assembly according to claim 2, wherein the displacement direction extends co-linearly with a travelling direction of the vehicle.

4. The pivot sliding door assembly according to claim 1, wherein the Y-direction fixing device, in the displacing position of the door wing, is alternatingly engageable and disengageable with the door wing.

5. The pivot sliding door assembly according to claim 4, wherein the Y-direction fixing device is disengageable from the door wing by pivoting the rotary column with the door wing.

6. The pivot sliding door assembly according to claim 1, wherein the rotary column assembly comprises a Z-direction fixing device engageable with the door wing in the closing position of the door wing, thereby limiting movement of the door wing in a Z-direction transversely to the displacement direction.

7. The pivot sliding door assembly according to claim 6, wherein the Z-direction, in relation to the vehicle, extends in a vertical direction.

8. The pivot sliding door assembly according to claim 7, wherein the Z-direction fixing device is engageable with the door wing so as to limit motion of the door wing in an upward Z-direction and a downward Z-direction.

9. The pivot sliding door assembly according to claim 6, wherein the Y-direction fixing device includes the Z-direction fixing device.

10. The pivot sliding door assembly according to claim 9, wherein engagement of the Y-direction fixing device with the door wing fixes the door wing in the Z-direction.

11. The pivot sliding door assembly according to claim 1, wherein the rotary column assembly includes an X-direction pressing device engageable with the door wing in the closing position of the door wing and configured to press the door wing in an X-direction.

12. The pivot sliding door assembly according to claim 11, wherein the X-direction extends perpendicularly to the displacement direction and perpendicularly to the Z-direction.

13. The pivot sliding door assembly according to claim 12, wherein the X-direction extends horizontally in relation to the vehicle.

14. The pivot sliding door assembly according to claim 11, further comprising a second door wing configured to open and close the door opening, wherein the second door wing is displaceable between a second closing position and a second displacing position, and wherein the door wing, when in the closing position, together with the second door wing, when in the second closing position, covers the door opening and the X-direction pressing device presses the door wing, when in the closing position, against the second door wing, when in the second closing position.

15. The pivot sliding door assembly according to claim 14, wherein the pivot sliding door assembly defines a portal delimiting the door opening and the X-direction pressing device presses the door wing in the closing position against the portal.

16. The pivot sliding door assembly according to claim 1, wherein the door wing defines an opening configured to receive the Y-direction fixing device and the Y-direction fixing device is displaceable into the opening to engage the door wing.

17. The pivot sliding door assembly according to claim 14, wherein the opening is located near an end region of and adjacent to the linear bearing.

18. The pivot sliding door assembly according to claim 1, wherein the Y-direction fixing device includes a hook configured to engage the door wing.

19. The pivot sliding door assembly according to claim 16, wherein upon engagement of the Y-direction fixing device, the hook engages behind an engaging edge of the opening.

20. The pivot sliding door assembly according to claim 19, wherein when the hook engages the engaging edge of the opening, the door wing is pressed in the X-direction.

21. The pivot sliding door assembly according to claim 18, wherein the opening defines an elongated hole oriented along the displacement direction.

22. The pivot sliding door assembly according to claim 21, wherein the opening is located below the linear bearing.

23. The pivot sliding door assembly according to claim 19, wherein the opening defines sub-edges delimiting the engaging edge and configured to block a relative movement of the hook towards the opening transversely to the displacement direction.

24. The pivot sliding door assembly according to claim 23, wherein the sub-edges are configured to block a relative movement of the hook both upwardly and downwardly in the Z-direction, by a form-fit with the hook.

25. The pivot sliding door assembly according to claim 24, wherein a clearance of the hook in the opening in the Z-direction is smaller than a clearance of the guiding element in the linear bearing in the Z-direction.

26. The pivot sliding door assembly according to claim 18, wherein the hook is located at a pin of the rotary column lever.

27. The pivot sliding door assembly according to claim 26, wherein the hook is located near a door wing side end of the rotary column lever.

28. The pivot sliding door assembly according to claim 27, wherein the pin is oriented vertically downwards.

29. The pivot sliding door assembly according to claim 18, wherein the hook is oriented substantially along a horizontal plane of the vehicle.

30. The pivot sliding door assembly according to claim 29, wherein the hook is bent in a direction that corresponds to a pivot direction of the rotary column for displacing the door wing into the closing position.

31. The pivot sliding door assembly according to claim 1, wherein the rotary column lever is pivotably supported at the rotary column.

32. The pivot sliding door assembly according to claim 31, wherein the rotary column lever is displaceably supported with the guiding element in the linear bearing.

33. The pivot sliding door assembly according to claim 32, wherein the guiding element includes a rolling element configured to linearly roll the door wing along a guide.

34. The pivot sliding door assembly according to claim 31, wherein the linear bearing defines a longitudinal profile.

35. The pivot sliding door assembly according to claim 34, wherein the longitudinal profile defines a profile cross section that is open only in a first transverse direction.

36. The pivot sliding door assembly according to claim 35, wherein the rolling element is rotatably supported at an axis of rotary column lever that, along the transverse direction, protrudes into the longitudinal profile and is located at a door wing side end of the rotary column lever.
